(19) United States
(12) Patent Application Publication
(10) Pub. No.: US 2018/0142495 A1
(43) Pub. Date: May 24, 2018

(54) GAWKER FENCE DESIGNED AS A VISUAL SCREENING SYSTEM

(71) Applicant: Dieter Wolfgang MOHN, Ludwigslust (DE)

(72) Inventor: Dieter Wolfgang MOHN, Ludwigslust (DE)

(21) Appl. No.: 15/818,276

(22) Filed: Nov. 20, 2017

(30) Foreign Application Priority Data
Nov. 22, 2016 (DE) 20 2016 007 133.6
Nov. 7, 2017 (EP) 17 200 435.0

(51) Int. Cl. E04H 17/00; E01F 13/02; E06B 9/24; F21V 33/00

(52) U.S. Cl. CPC E04H 17/00; E01F 13/028; F21Y 2115/10; F21V 33/00; E06B 9/24

(57) ABSTRACT

The invention concerns a visual screening system wherein the visual screening system is fabricated as a mobile barrier device made of textile material.

### PRIORITY

This application claims priority from DE 20 2016 007 133.6, filed Nov. 22, 2016, and from EP 17 200 435.0, filed Nov. 7, 2017, and the entire content of both applications is hereby incorporated by reference.

### BACKGROUND OF INVENTION

### Field of Invention

The invention concerns a visual screening system used as a screen at accidents, crime scenes or other areas which are to be secured against viewing. The visual screening system can also be described as a gawker fence system.

### Brief Description of Related Art

DE 297 14 038 U1 discloses an apparatus for securing places, particularly for securing accident locations, with a tubular frame made of elastic material which can be filled with air, and with a screen mounted between lateral supports of the tubular frame.

### BRIEF SUMMARY OF THE INVENTION

It is an object of the present invention to specify a visual screening system and a method for operating a visual screening system with which a visual screening system can be set up very quickly and efficiently and operated safely.

This object is solved by a visual screening system which is further developed by the visual screening system being fabricated as a mobile barrier device made of textile material. This way a very light visual screening system can be provided, which can be moved and set up very quickly due to its low weight.

The visual screening system is preferably filled with compressed air or can be filled with compressed air, wherein the visual screening system particularly raises itself as a result of the air pressure of the compressed air.

Preferably a self-supporting framework is provided as a skeleton construction in which at least one part of the self-supporting framework, preferably the entire self-supporting framework, is fabricated from tubes.

Preferably an upper beam and pillars are provided, wherein in particular textile screen areas are attached on the upper beam and are fixed between the pillars. The pillars are preferably arranged at an angle to one another and formed as legs and thus ensure that the visual screening system can stand by itself, thus requiring no further support. In the context of the invention a pillar can also be described as a pylon or stand. In particular, the self-supporting framework of the visual screening system is triangular in form in a cross-section.

Preferably two lower beams are provided which in particular are held apart by braces. Here the braces can be made of fiberglass-reinforced plastic, for example. The two lower beams and the upper beam are preferably connected to the pillars in such a way that a triangular shape of the self-supporting framework results in the cross-section. Furthermore, the beams and pillars are constructed in a tubular manner and in particular connected to one another so that the interior of the tubes can communicate with one another, allowing compressed air to flow into each beam and each pillar.

The visual screening system is preferably extended lengthwise and has an upper beam and two lower beams and pairs of pillars in each case, with multiple pairs of pillars provided which connect the upper beam with the two lower beams. In a simple, short embodiment, three pairs of pillars can be provided, and in a longer embodiment and also more stable embodiment, four, five, six, seven, eight and preferably nine or ten or more pair of pillars can be provided. The pairs of pillars are preferably designed so that they are constructed in the form of an inverted “V”. Preferably the pairs of pillars are connected with the upper beam at the same place toward the top and on the bottom to the lower beams in a direction perpendicular to the lengthwise extension of the visual screening system in the same plane as the connection with the upper beam.

The visual screening system is preferably stabilized by ballast. Here it can be provided that the ballast made of self-filling water reservoirs ensures stability at the base of the visual screening system. The ballast can also be constructed such that a ballast strip is first rolled out, and then the visual screening system is placed on it. The ballast strip itself then has a sufficiently high weight. A ground sheet or ground strip can also be provided which has braces, in particular cross braces, which are provided in particular in the area of the pillars in order to space the pillars and/or the lower beams. Then a weight, such as a sandbag, can be placed on these braces. Preferably the ballast strip is constructed as a ground strip.

Preferably the lower beams can be connected to the ground strip or ballast strip in a detachable manner using snap hooks. Here the attachment of snap hooks is preferably situated in the area of the braces. Protective covers are preferably provided for the snap hooks, in particular ones made of textile material, in particular ripstop. The protective covers are preferably sewn around the snap hooks on the outside.

The visual screening system is preferably equipped with warning lights, which in particular are constructed as LED warning lights.

Furthermore, LED lamps are preferably used for illuminating the environment of the visual screening system. The LED lamps used for illumination are preferably equipped in addition to the LED warning lights.

If these are provided with zippers for venting the visual screening system, the air can be removed and disassembly of the visual screening system can take place very quickly.

The textile material is preferably a ripstop, in particular a ripstop nylon. This can be coated, but need not be. The ripstop material is preferably essentially airtight or airtight at the air pressures used. Moreover, ripstop is very light and relatively thin. Ripstop is also very resistant to tearing. The weight per unit area comprises, for example, 60 to 70 g/m² and there can be a polyurethane (PU) or silicone coating for waterproof, airtight and/or fire-safe design. Thus excellent weight and stability conditions and high tear resistance can be provided.

A pressure blower is preferably used to fill the visual screening system with compressed air. The material used (such as ripstop) can be sewed together or glued, for example to form tubes and connections between the respective tubes. The connections, for example seams, can be designed in such a way that a little air pressure can escape. The use of a pressure blower makes it unnecessary to use a completely airtight material. In fact, with the operation of the compressed air blower, the visual screening system can remain upright even if some air escapes.

The visual screening system is preferably rolled up prior to setup, i.e. a transport spool is provided on which the visual screening system can be placed. To set up the visual screening system, the transport spool provided with visual screening system can be carried to the setup location using brackets attached to the transport spool, for example. Then the visual screening system can simply be unrolled and subsequently provided with compressed air, for example by the compressed air blower. In this way the visual screening system erects itself. Thus the invention is also solved by a method for operating a visual screening system described above, in which to set up the visual screening system it is unrolled on a ground and then inflated with a pressure blower, so that the visual screening system erects itself.

The compressed air blower can be connected to the visual screening system via a tube opening. The compressed air blower is preferably attached to the tube opening with a VELCRO® fastener.

The pressure blower is preferably switched off to dismantle the visual screening system, and the visual screening system is rolled up, with the air escaping from the tubes via seams, open zippers and/or an opening at the pressure blower.

The geometric form of the visual screening system is an important difference with respect to prior art. This can be very long: for example, 10 m, 20 m or 30 m. A width of 80 cm to 1.6 m can be provided, preferably about 1 m or 1.1 m or 1.2 m. The height is 2 meters or somewhat higher, for example 2.1 m, 2.2 m or 2.3 m. The weight of the visual screening system without the weight of the compressed air blower or pressure blower is preferably 60 kg with a 20 m length. The spool diameter comprises about 1.2 m in the rolled-up condition of the visual screening system on the transport spool.

Altogether a very efficient visual screening system, which erects itself very safely and quickly and which stands in a stable manner, results from the geometry envisaged, for example a shape which is triangular in section, in which the two lower beams which extend in the lengthwise extension of the visual screening system and are designed as a tube, as well as an upper beam which also extends in the lengthwise extension of the visual screening system and is arranged essentially parallel or parallel to the two lower beams, and multiple pillars which are also designed as pairs of tubular pillars, in which each pillar extends from a lower beam to the upper beam.

It is particularly preferred if the pressure blower essentially blows continuously or, alternatively, blows as long as a specifiable pressure limit is not undershot. For this, in the area of the pressure blower or in the visual screening system removed from the pressure blower a pressure sensor can be provided to ensure that sufficient pressure is present. It is preferable if a certain small amount of air can also escape from the visual screening system so that it is also easily possible to roll up or respectively, dismantle the visual screening system.

LED warning lights can be provided to increase safety. Further LED lamps installed are used to illuminate the surroundings. The gawker fence system or respectively, visual screening system is a visual screening system which erects itself with compressed air. Stability is insured by self-filling water reservoirs in the base of the gawker fence system, which represents an embodiment of the invention. The system is ready for use anywhere on short notice, for example with about 10 minutes of setup time and lately even with only two minutes of set up time even by people who have never previously set up the visual screening system. The visual screening system can be installed in emergency vehicles or a trailer or be removable there. The following contents can be provided: Gawker fence system, water reservoir with approximately 1 m³ (1000 kg ballast), a power unit and pressure blower.

The gawker fence system is rolled out to set it up. The ballast water flows simultaneously into both reservoirs in the base. The tube reservoirs are held apart by braces. A pressure blower fills the tubes of the stands with air. The warning illumination can be switched on, and in the night LED spotlights light up the surroundings.

One aspect of the invention is that the gawker fence or respectively, visual screening system is fabricated as a mobile barrier device made of textile material. Another aspect of the invention is that the visual screening system is filled with compressed air.

A further aspect of the invention is that the visual screening system has a self-supporting framework with the skeleton construction, which holds up the textile screen areas which are attached to the upper beam and fixed between the pillars.

A further aspect of the invention is that the gawker fence is stabilized with ballast.

A further aspect of the invention is that the gawker fence or respectively, visual screening system is equipped with LED illumination and warning lights.

A further aspect of the invention is that the gawker fence or respectively, visual screening system is equipped with zippers for ventilation and can be rolled up for transport.

In the context of the invention, a visual screening system is preferably also a gawker fence. A visual screening system can preferably also be regarded as a visual screening wall.

Further characteristics of the invention are apparent from the description of inventive embodiments together with the claims and the drawings included. Inventive embodiments can meet individual characteristics or a combination of multiple characteristics. In the scope of the invention, features which are indicated with phrases like “particularly” or “preferably” are to be understood as optional features.

### BRIEF DESCRIPTION OF THE DRAWINGS

The invention is described below, without restricting the general intent of the invention, based on examples with reference to the drawings; we expressly refer to the drawings with regard to the disclosure of all details according to the invention that are not explained in greater detail in the text. These show:

FIG. 1 shows a schematic sectional view through an inventive visual screening system,

FIG. 2 shows a schematic side view of part of an inventive visual screening system,

FIG. 3 shows an inventive visual screening system schematically in a three-dimensional representation,

FIG. 4 shows a schematic side view of another inventive visual screening system,

FIG. 5 shows a top view of the visual screening system from FIG. 4,

FIG. 6 shows parts of the visual screening system in a schematic, three-dimensional exploded view representation,

FIG. 7 shows a schematic three-dimensional representation of a ground strip and

FIG. 8 shows a schematic sectional view of an inventive visual screening system.

In the drawings, the same or similar types of elements or parts are provided with the same reference numbers in order to avoid the need for redundant presentation in each case.

### DETAILED DESCRIPTION OF THE INVENTION

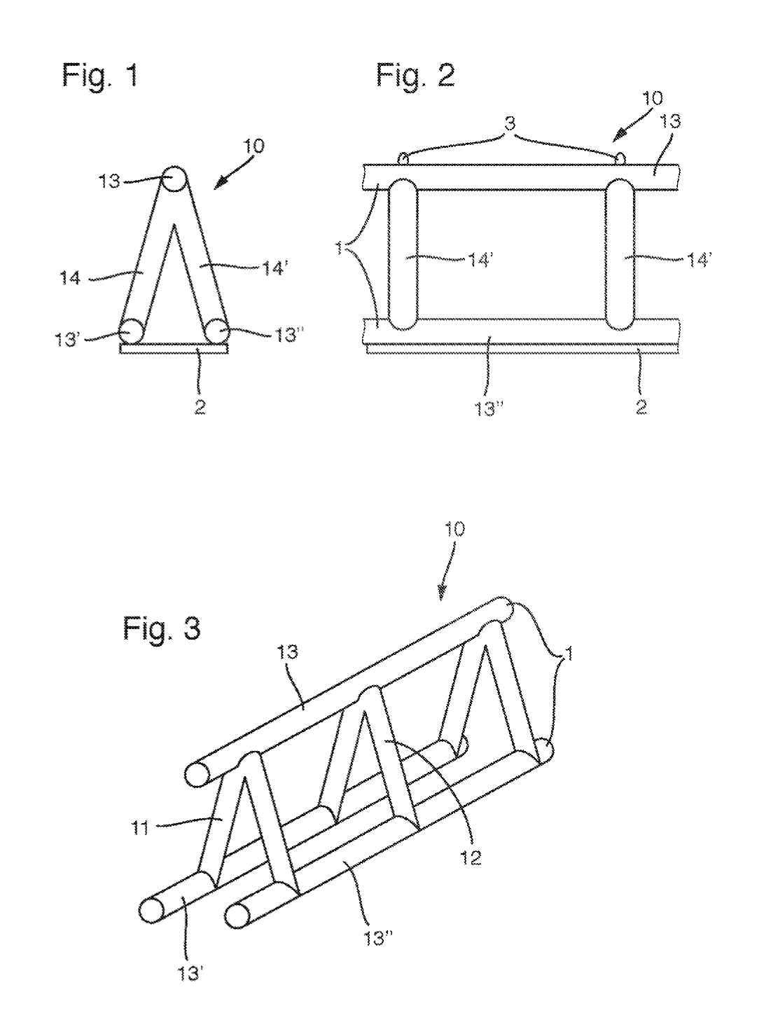

FIG. 1 shows a sectional view through an inventive visual screening system 10. A corresponding schematic side view of a section of the visual screening system 10 is shown in FIG. 2, and a three-dimensional representation is shown schematically in FIG. 3.

The visual screening system 10 has a triangular section. This is based on the arrangement of the tubular pillars 14, 14′, which, as the name suggests, are pillars which are designed as tubes and are connected with the lengthwise extending beams 13, 13′, 13″, which are also designed as tubes. The pillars 14, 14′ are arranged at an acute angle with respect to one another, preferably at an angle of 25° to 40°, especially 35°. In a width of 1.2 m, which can be seen in FIG. 1 from left to right, and a height of 2.1 m, and angle of about 32° results. The tubular pillars 14, 14′ are communicatively connected with the tubular beams 13, 13′, 13″.

The pillars 14, 14′ are fabricated from textile material 11 in each case, for example from ripstop, and are sewn and/or glued together with one another and with the beams 13, 13′, 13″ for connection. The beams, which are designed as tubular beams 13, 13′, 13″, are made of ripstop.

To connect the ballast 2, which can be designed as a ballast water reservoir or as heavy sheeting or as a ground strip made heavier with ballast sacks, with the rest of the visual screening system. VELCRO® fasteners can be connected with the lower beams 13, 13′, 13″, for example. The VELCRO® fasteners are not shown here. Another form of connection can also be provided.

FIG. 2 also shows an illumination 3 very schematically, which can be warning illumination or even provided with an illumination with which the area of the visual screening system can be lit. The illumination 3 can be constituted as an LED lamp.

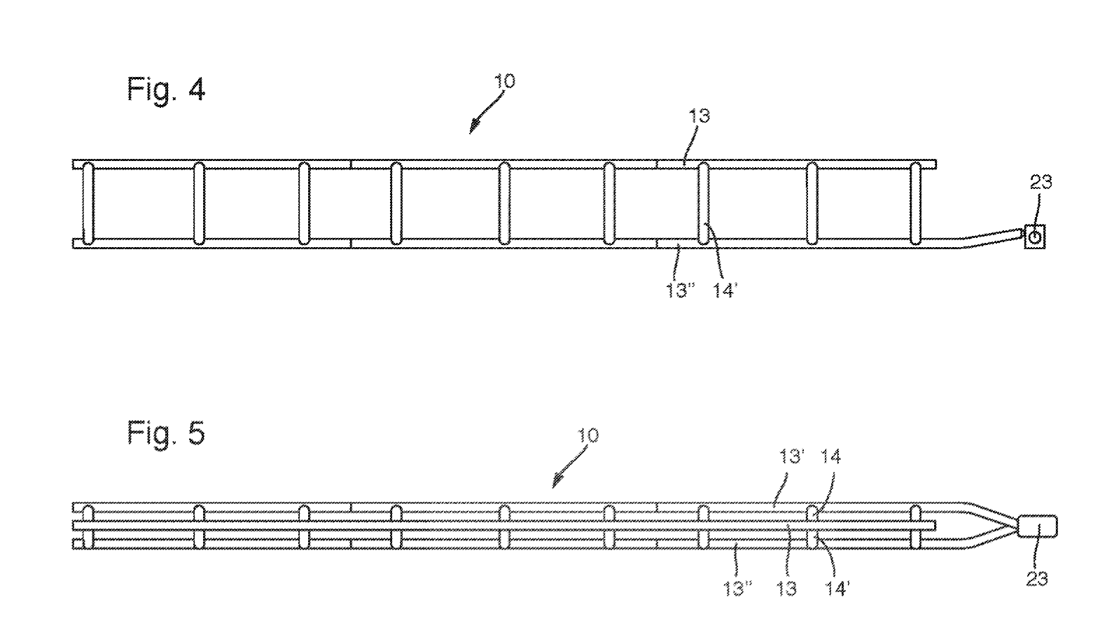

A further embodiment in FIG. 4 shows an inventive visual screening system 10 which, as an example, can be 20 m long and have nine pairs of pillars. In this Figure, only the tubular pillars 14′ are shown which lie toward the observer. A lower tubular beam 13″ is shown. The other lower tubular beam 13′ lies in the plane of projection behind the tubular beam 13″. The upper beam 13 is also shown. The beams can consist of multiple tubes put together as shown by the two lines in beams 13 and 13″in each case. However, these can also be of a single piece.

However, the visual screening system 10 can also be extendable length-wise in a modular fashion, so that, for example, in each case parts of a visual screening system consisting of an upper tubular beam 13, to lower tubular beams 13′ and 13″ and three pairs of tubular pillars in each case are connected with each other at the beams or respectively, via the beams. In FIG. 4 that would then be three modules connected to one another. Connection can be made, for example, with VELCRO® fasteners. However, this is only one of the conceivable variations of the inventive visual screening system 10.

The visual screening system 10 is inflated using a compressed air blower 23, which is linked communicatively with both lower beams 13′ and 13″ via corresponding tubes. This is represented better in FIG. 5, which shows an inventive visual screening system 10 in a schematic top view.

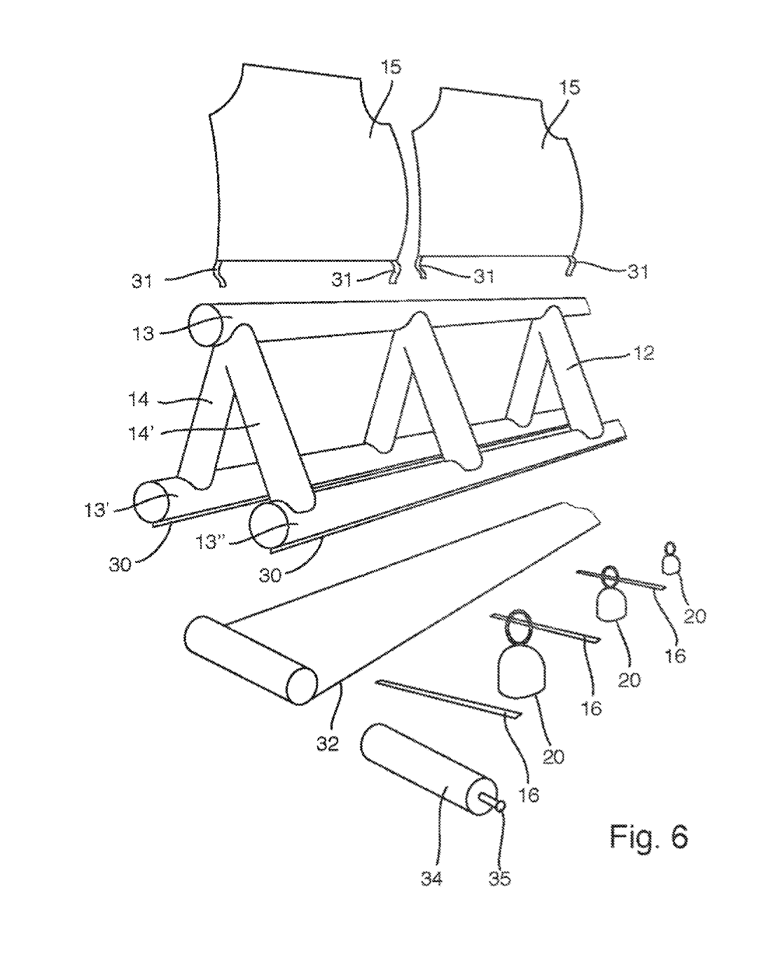

The screen areas were left out for the previous visual screening systems 10 to simplify the representation. These screen areas 15 are shown in FIG. 6. FIG. 6 shows a schematic three-dimensional exploded view of the components of an inventive visual screening system 10, comprising an upper beam 13, two lower beams 13′ and 13″ and three pillars 14 and 14′ in each case. Together these comprise the framework 12 of the visual screening system 10. The beams and also the ground strip 32, on which the lower beams 13′ and 13″ are placed, are shown in a truncated manner in the back area of FIG. 6, so that the visual screening system will in fact ultimately be somewhat longer.

The framework 12 is placed on the ground strip 32 using a VELCRO® strip 30, for example. A counterpart to the VELCRO® fastener is also provided for this, but is not shown. Furthermore, braces 16 are placed on the ground strip or respectively, incorporated into it, said braces being oriented cross directional to the lengthwise extension of the ground strip 32 and also to the visual screening system 10, in particular perpendicular to it. These ensure that the two lower beams 13′ and 13″ are kept spaced apart. The braces 16 thus provide stability. In order that the visual screening system not fall over during a corresponding wind, sandbags 20 are provided as ballast, which are preferably placed on the ground strip 32.

The ground strip 32 can, for example, be made of high strength PVC sheeting or of high strength PVC textile with a weight of 650 g/m². The braces 16 can be made of fiberglass-reinforced plastic, and have dimensions of 1000 mm×40 mm×20 mm. The sandbags can be waterproof, made of PVC for example and be filled with dry gravel or stone chips and have a weight of 10 to 12 kg. The bottom strip or ground strip 32 with the framework 12 or respectively, bearing skeleton preferably made of airtight ripstop (of 60 bis 70 g/m² nylon), in particular sewn with highly tear resistant thread, and the screen areas 15, which can be made of textile permeable to air, for example with 110 g/m², and preferably colored individually with printing, can be rolled together on a transport spool and winder or a spool and unrolled from it. The spool 34 can be a PVC pipe with a dimension of 100 mm×1000 mm. Plastic bushings are preferably provided. The spool 34 can be welded to the ground strip so that they are always connected to one another. Furthermore, a bracket 35 is provided in the form of an aluminum tube system which can be pulled out or telescoped for simple transport of the rolled-up visual screening system.

The screen areas 15 can be connected to the ground strip 32 below with VELCRO® fasteners 31 and the attached at the top in a corresponding manner between the pillars 14 and/or on the lower part of the upper beam 13.

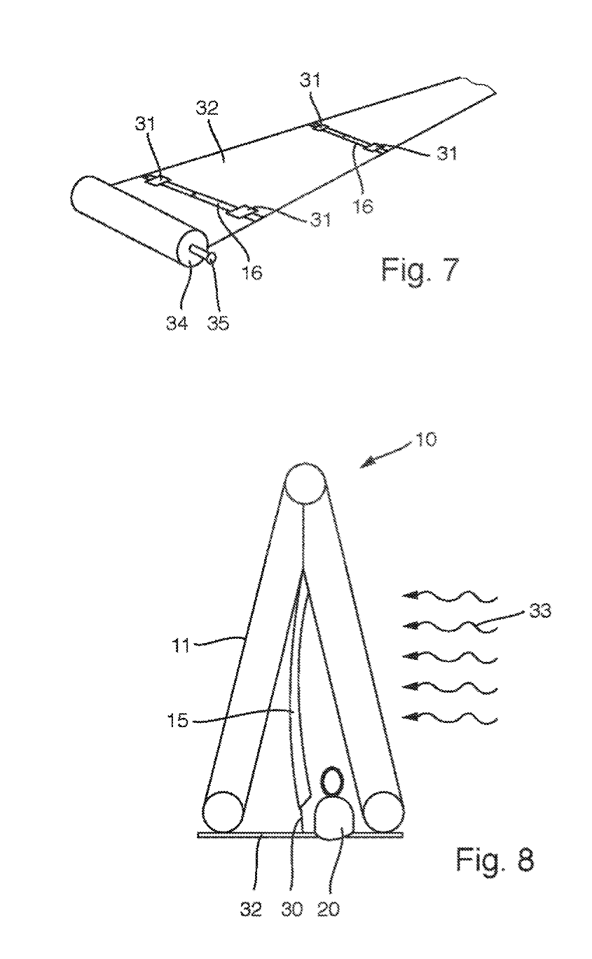

FIG. 7 shows a ground strip 32 once again, on which the braces 16 are placed. VELCRO® strips 31 are placed on the braces 16 to hold the corresponding VELCRO® strips 30 attached under the lower beams 13′ and 13″.

FIG. 8 shows a schematic sectional view through an inventive visual screening system in which one screen area 15 is also now shown, which is provided with a VELCRO® fastener 30 that can be connected to the ground strip 32. A corresponding weight 2 or sandbag 20 is also shown, which in this case comprises the significant part of the ballast to in order to ensure that the visual screening system 10 does not fall over even with corresponding wind 33. Preferred dimensions are a height of 2.1 m and a width of 1 m from the middle of the lower beams 13 and 13′ with respect to one another. Furthermore, a preferred length for the visual screening system is 20 m, with a longitudinal axial spacing for the pillars of 2.3 m. In the packaged condition, the visual screening system can be designed with a length of 104 cm and a spool diameter of 35 to 38 cm with a weight of 27 kg. The compressed air blower can be from the company Gibbons and have a power rating of 1.4 kW. A funnel diameter of 20.5 cm can be provided and a maximum air throughput of approximately 2600 m3/h. The sandbags should preferably be arranged on the side from which the wind blows.

All features described, including those found only in the drawings and as well as individual features which are disclosed in combination with other features, are considered by themselves and in combination as important for the invention. Individual features or a combination of multiple features can be achieved by embodiments in accordance with the invention.

### DRAWING REFERENCE LIST

1 Compressed air

2 Ballast

3 Illumination

10 Visual screening system

11 Textile material

12 Framework

13, 13′, 13″ Tubular beam

14, 14′ Tubular pillar

15 Screen area

16 Brace

20 Sandbag

23 Compressed air blower

30 VELCRO® strip

31 VELCRO® strip

32 Ground strip

33 Wind

34 Spool

35 Bracket

What is claimed is:

1. A visual screening system, wherein the visual screening system is a mobile barrier device made of textile material.

2. The visual screening system according to claim 1, wherein the visual screening system is configured to be fillable with compressed air such that the visual screening system raises itself due to an air pressure of the compressed air.

3. The visual screening system according to claim 1, further comprising a self-supporting framework as a skeleton construction, and wherein at least one part of the self-supporting framework is fabricated from tubes.

4. The visual screening system according to claim 3, wherein an upper beam and pillars are provided, and wherein textile screen areas are attached on the upper beam and are fixed between the pillars.

5. The visual screening system according to claim 1, wherein two lower beams are provided, which are held apart by braces.

6. The visual screening system according to claim 1, wherein the visual screening system is stabilized by ballast.

7. The visual screening system according to claim 1, wherein the visual screening system is provided with warning lights.

8. The visual screening system according to claim 7, wherein the warning lights are LED warning lights.

9. The visual screening system according to claim 1, wherein LED lamps are used to illuminate surroundings of the visual screening system.

10. The visual screening system according to claim 1, wherein the visual screening system is provided with zippers for removing air from the visual screening system.

11. The visual screening system according to claim 1, wherein the textile material is a ripstop material.

12. The visual screening system according to claim 11, wherein the ripstop material is a ripstop nylon material.

13. A method for operating a visual screening system according to claim 1, comprising unrolling the visual screening system on a ground surface and inflating the visual screening system with a pressure blower such that the visual screening system erects itself.

14. The method according to claim 13, further comprising switching off the pressure blower and rolling up the visual screening system, with air escaping from tubes via seams, open zippers and/or an opening at the pressure blower.
